(19) United States
(12) Patent Application Publication
(10) Pub. No.: US 2016/0042568 A1
(43) Pub. Date: Feb. 11, 2016

(54) Computer system generating realistic virtual environments supporting interaction and/or modification

(71) Applicants: Taylor Farnham, Cambridge, MA (US); Andrew Prestridge, Ojai, CA (US)

(72) Inventors: Taylor Farnham, Cambridge, MA (US); Andrew Prestridge, Ojai, CA (US)

(73) Assignees: Andrew Prestridge, Ojai, CA (US); Taylor Farnham, Ojai, CA (US)

(21) Appl. No.: 14/819,249

(22) Filed: Aug. 5, 2015

Related U.S. Application Data
(60) Provisional application No. 62/034,937, filed on Aug. 8, 2014.

(51) Int. Cl. G06T 19/00; G06T 19/20; G02B 27/01

(52) U.S. Cl. CPC G06T 19/006; G02B 27/0176; G06T 19/20

(57) ABSTRACT

A computer system capable of generating realistic virtual environments [4] from real world environments [1] with the ability to convey supplemental information [5] pertaining to the contents of the virtual environment [4] as well as the ability to modify the virtual environment [4] and receive cost/time estimates [10] to realize these modifications [8] within the real-world environment [1].]

### CROSS-REFERENCE TO RELATED APPLICATIONS

This application claims the benefit of U.S. Provisional App. 62/034,937, filed Aug. 8, 2014, the entirety of which is incorporated herein by reference.

### BACKGROUND OF THE INVENTION

The present invention relates to a computer system able to generate virtual immersive, interactive tours in outdoor and/or indoor environments and to collect and display supplemental information related to the contents of the tour.

The current state of the art tools rely primarily on two methods of three-dimensional visualizations: movies/animations and panoramic views. Movies/animations are recorded or created representations that follow a pre-defined path without user interaction, other than stopping, starting, or controlling the speed of the viewing. Panoramic views allow for the 360° viewing of a particular scene from a fixed viewpoint. The user may pan, tilt, and/or zoom the panoramic view, however each view originates from a single fixed point and the user cannot interact with objects within the panoramic views. With regards to collecting and displaying information, each element must be included into the movie/animation or panoramic view prior to its completion and does not permit user interaction. The user cannot control what, if any, information is presented. In addition, included information cannot be changed or altered without recreating the entire view.

### BRIEF SUMMARY OF THE INVENTION

The present invention is a system that enables users to explore a three-dimensional virtual representation of an indoor and/or outdoor environment that provides an immersive and realistic experience and is generated from a real-world environment.

The present invention also allows supplemental information entered by users to be shown as part of the virtual environment, and to be triggered on or off at the discretion of the users, at any point or at multiple points throughout the users' exploration.

The present invention also enables users to modify objects within the environment, and includes a system to allow external users, such as contractors, to view the virtual environment, generate estimates and/or quotes to realize said modifications in the real-world environment, make alternate modifications, and send the estimates and/or quotes and modifications to the users.

The present invention also allows for multiple users to simultaneously explore the same virtual representation and interact with other users as well as the environment.

### BRIEF DESCRIPTION OF THE DRAWINGS

The present invention will now be described by way of illustration without limitation, according to a preferred embodiment, with particular reference to the figures of the annexed drawings in which:

FIG. 1 is a block diagram of the interactions between the real environment and a virtual environment, used to create an immersive interactive experience for users.

FIGS. 2A, 2B, 2C are simplified representations of the potential applications for supplemental information within the realistic virtual environment.

FIGS. 3A, 3B are simplified representations of the potential applications for supplemental information provided from the external network as shown in the realistic virtual environment.

FIG. 4 is a block diagram of the interactions between multiple users and the virtual environment.

### DETAILED DESCRIPTION OF THE INVENTION

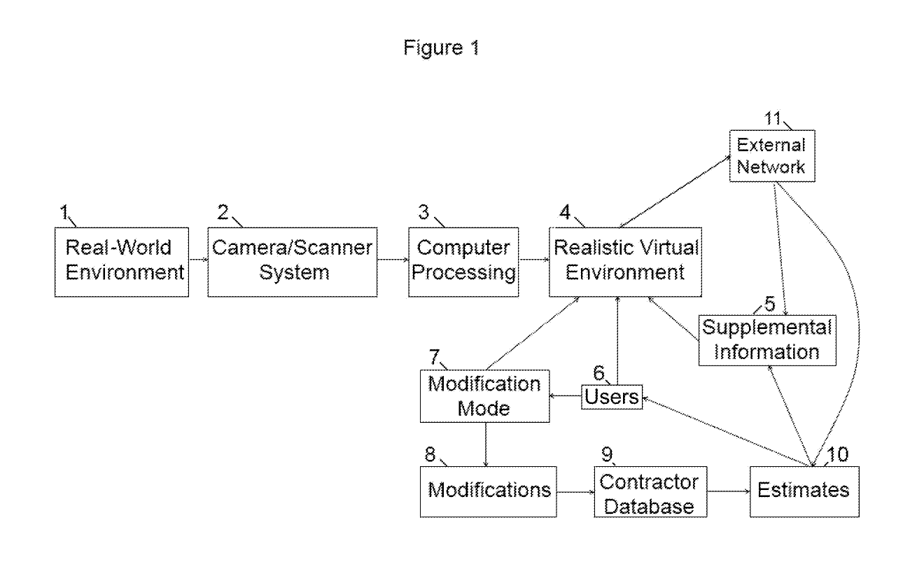

The present invention is to provide a system that captures realistic and accurate representations of a real-world environment and generates a three-dimensional realistic virtual environment through which users [6] can wander and explore. Referring to FIG. 1, a scanner or camera system [2] is used in such a manner to capture physical dimensions and/or the appearance of the real-world environment [1], such as the interior, exterior, and surroundings of a building or property. The information from the scanner or camera system [2] is transmitted to a computer processing unit [3] from which a three-dimensional realistic virtual environment [4] is generated. Supplemental information [5] from the real-world environment [1] may be embedded into the realistic virtual environment [4]. The realistic virtual environment [4] and supplemental information [5] may be transmitted to an external network of second users [11]. The external network [11] may add, remove, or modify the supplemental information [5] and may provide cost/time estimates [10] to perform services on the objects and environment contained within the realistic virtual environment [4].

The supplemental information [5] may include, but is not limited to: the price and/or value of contained objects; the history of contained objects or architecture; structural or architectural plans, features, and designs; the location of above and underground utility lines, including electricity, water, sewage, gas, and telecommunications; the location of plumbing and wiring within walls of contained structures; and general information pertaining to the real-world environment [1] or its surroundings. The supplemental information [5] may also include, but is not limited to: feedback, comments, opinions, or thoughts from the external network [11]; indications of positive, negative, or neutral preference from the external network [11]; and offers from the external network [11] or elsewhere to purchase, modify, or alter the contents of the realistic virtual environment [4].

Users [6] may then wander through and explore the realistic virtual environment [4] and may interact with the virtual objects contained within. Users [6] have control to move the viewpoint and rotate the current view as if one were walking through the real-world environment [4] and looking around. Users [6] may also move the viewpoint vertically upwards or downwards, as if one were flying or hovering in the real-world environment [4]. Such actions may generate perspectives and viewpoints that could not be achieved in the real-world environment [1] without additional equipment, such as a ladder. Users [6] may also interact with objects contained within the realistic virtual environment [4]. Such interaction may include, but is not limited to: opening doors, cabinets, or windows; lifting, rotating or translating objects; turning on or off lights or faucets; causing objects to appear or disappear; turning on or off or modifying the intensity or amplitude of sound or electromagnetic wave-emitting devices; assembling or disassembling objects which consist of multiple components; manipulating objects with or without regard for the physical consequences of such manipulation; and operating devices, tools, appliances, and/or equipment as it would be operated in the real-world environment [1]. By interacting with the objects the users [6] can effect an immediate real-time change in the realistic virtual environment [4]. Such changes may allow for experimentation with regards to object positioning to achieve desired aesthetics, lighting conditions, or sound/wave levels throughout the realistic virtual environment [4] to be translated to the real-world environment [1]. Such changes may also allow for the simulation of: the operation of one or more objects, the interaction between one or more objects, or the interaction between one or more objects and the environment. The means and methods of said simulations or interactions may then be translated to the real-world environment [1].

The users [6] may also enter and exit a modification mode [7] through which the users [6] can make modifications [8] to additional elements of the realistic virtual environment [4]. Such elements include the fundamentals of the environment itself, including, but not limited to: ground or floors, walls, roof or ceiling, grade of land, trees or plants, or other physical elements of the environment. Modifications [8] may include, but are not limited to: replacing flooring, such as installing carpet, wood flooring; painting walls, ceilings, or other surfaces; planting or removing trees, plants; re-grading landscape elements; and construction efforts such as adding, moving, or relocating walls, windows, and other architectural elements. Information pertaining to these modifications [8] may be further transmitted to appropriate contractors [9] capable of realizing said modifications [8] and sending cost and/or time estimates [10] to the users [6]. The users would make information for a modification available to an external network of second users, including contractors or retailers, requesting estimates from each, as a homeowner gathers estimates from several contractors for a remodeling job, and chooses the best.

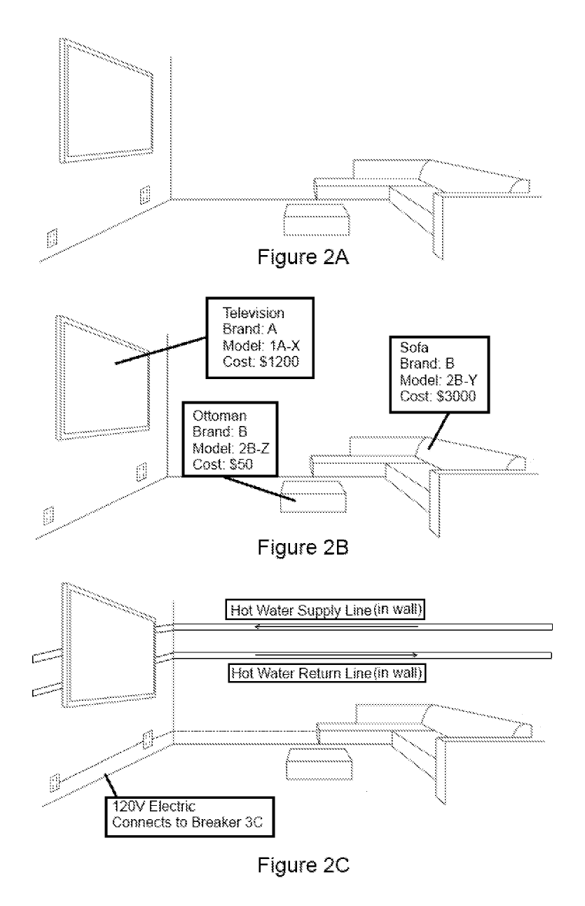

FIGS. 2A, 2B, 2C show configurations of supplemental information [5] within the realistic virtual environment [4]. Specifically, FIG. 2A is a representation of the realistic virtual environment [4] with the supplemental information [5] hidden. FIG. 2B is a similar representation, but with supplemental information [5] pertaining to the objects within the realistic virtual environment [4] shown—specifically what each object is, its brand and model numbers, and the cost of the object. FIG. 2C is a similar representation, but with the supplemental information [5] pertaining to the fundamental infrastructure of the realistic virtual environment [4] shown—specifically the electric and plumbing lines embedded in the walls are shown and briefly described. Electrical information such as breaker and breaker capacity may be shown for power lines, while flow rate and direction may be shown for plumbing lines.

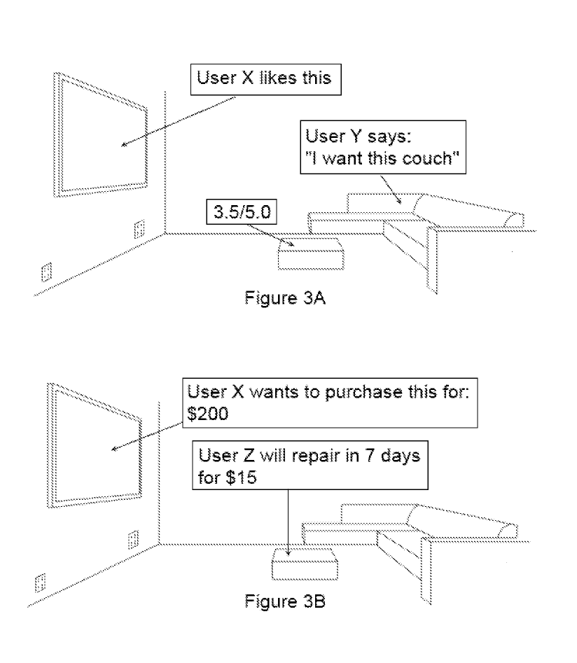

FIG. 3A is a similar representation as FIG. 2A but with supplemental information [5] from the external network [11] shown—specifically comments and indications of preference. FIG. 3B is a similar representation but with supplemental information pertaining to offers to purchase, modify, or alter the contents of the realistic virtual environment [4] shown.

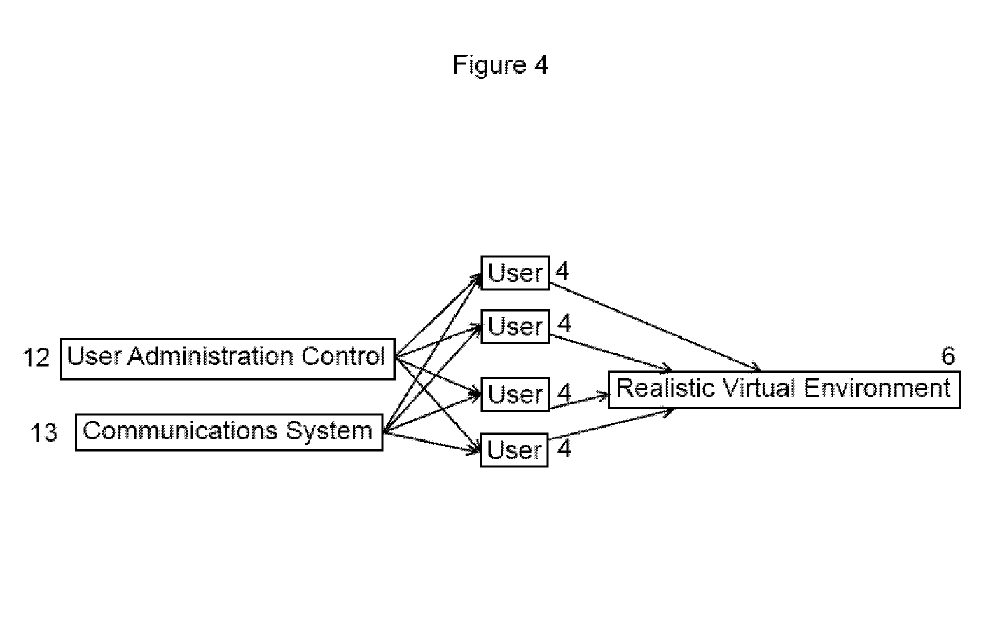

FIG. 4 shows a block diagram of the potential interaction between multiple users and the realistic virtual environment [4]. Each user [6] may retain the same rights, privileges, and/or abilities as the user [6] described within. However, a user administration control [12] may be implemented to restrict, modify, or otherwise alter the rights, privileges, and/or abilities for a specific users [6]. Users [6] may interact through a communications system [13], including but not limited to: audio, video, or text-based exchanges; graphic avatars with or without the expressions of the user [6]; and modifying or controlling the viewpoint and/or orientation of one or more users [6].

1. A computer and peripheral system which generates realistic, three-dimensional virtual environments representing real-world environments comprising:
a camera or scanner system to capture the physical dimensions and appearance of the real-world environment;
a computer processing unit that receives data from the camera or scanner system and generates the virtual environment representing the real-world environment;
a visual, or visual and auditory display, that displays the virtual environment to users, and;
an interaction system that enables users to interact with and alter the virtual environment.

2. The computer and peripheral system of claim 1, wherein the camera or scanner system is a structural sensor that scans real world environments and generates three-dimensional object files.

3. The computer and peripheral system of claim 1, wherein the display is a virtual reality visor.

4. The computer and peripheral system of claim 1, wherein the interaction system enables user alteration of the virtual environment by adding objects to, modifying objects in, and removing objects from the virtual environment.

5. The computer and peripheral system of claim 4, wherein the objects are furnishings, appliances, decorative, structural, architectural, utility or landscape items.

6. The computer and peripheral system of claim 4, wherein modifying objects includes opening doors, windows or cabinets, moving objects, turning lights or faucets on or off, causing objects to appear or disappear, modifying the volume of sound emitting devices, modifying the intensity of electromagnetic wave emitting devices, assembling or disassembling objects, manipulating objects, and operating devices, tools, appliances and equipment as they would be operated in the real-world environment.

7. The computer and peripheral system of claim 1, wherein the interaction system enables users to communicate with other users or affect their usage.

8. The computer and peripheral system of claim 7, wherein communication comprises audio, video, text-based exchanges, using graphical avatars, and modifying the orientation or viewpoint of other users.

9. The computer and peripheral system of claim 7, wherein affecting the usage of a user comprises restricting, modifying, or otherwise altering the rights, privileges, or abilities of that user.

10. The computer and peripheral system of claim 1, wherein the interaction system enables users to browse through and explore the virtual environment, and insert and display supplemental information in the virtual environment.

11. The computer and peripheral system of claim 10, wherein the supplemental information comprises prices, values or descriptions of the objects or any features of the virtual environment.

12. The computer and peripheral system of claim 10, wherein the supplemental information comprises structural, interior, furnishing or architectural plans, features, and designs.

13. The computer and peripheral system of claim 10, wherein the supplemental information comprises the location of above and underground utility lines, including electricity, water, sewage, gas, and telecommunications, and the location of plumbing and wiring within building floors, walls, and ceilings, and underground.

14. The computer and peripheral system of claim 10, wherein the virtual environment and supplemental information can be transmitted to an external network of second users who can modify the virtual environment and supplemental information.

15. The computer and peripheral system of claim 14, wherein the interaction system allows the users to enter and exit a modification mode, in which alterations of the virtual environment, and supplemental information pertaining to these alterations can be transmitted to appropriate contractors in the external network of second users, who can send to the users cost and/or time estimates to realize the alterations in the real-world environment.

16. The computer and peripheral system of claim 14, wherein the supplemental information can includes feedback, comments, and proposals.

17. The computer and peripheral system of claim 15, wherein the modification mode groups cost and/or time estimates for each alteration, so that when they are received, they are displayed together as a group of bids so that the users can select a preferred estimate.

18. The computer and peripheral system of claim 15, wherein the modification mode enables the users to receive supplemental information about contractors who send cost and/or time estimates to the users.

19. The computer and peripheral system of claim 17, wherein the supplemental information about contractors includes customer ratings.
